(19) United States
(12) Patent Application Publication
(10) Pub. No.: US 2009/0166546 A1
(43) Pub. Date: Jul. 2, 2009

(54) X-RAY DETECTOR AND METHOD FOR OPERATION OF AN X-RAY DETECTOR

(76) Inventors: Frank Fleischmann, Egloffstein (DE); Georg Wittmann, Herzogenaurach (DE)

Correspondence Address: SCHIFF HARDIN, LLP;PATENT DEPARTMENT, 6600 SEARS TOWER, CHICAGO, IL, 60606-6473, US

(21) Appl. No.: 12/088,353

(22) PCT Filed: Sep. 19, 2006
(86) PCT No.: PCT/EP2006/066513

§ 371 Date: Aug. 26, 2008

(30) Foreign Application Priority Data
Sep. 29, 2005 (DE) 10 2005 046 820.9

(51) Int. Cl. G01T 1/20

(52) U.S. Cl. 250/370.11

(57) ABSTRACT

An x-ray detector has a scintillator that emits light in response to exposure to x-ray radiation, and an activatable photosensor that detects the light from the scintillator. While the scintillator is being irradiated with x-ray radiation, the photosensor is inhibited from detecting the light for a predetermined time interval. After the irradiation of the scintillator with x-ray radiation ends, only then is the photosensor activated to detect light from the scintillator. An x-ray image of better quality is thereby obtained.

### BACKGROUND OF THE INVENTION

1. Field of the Invention

The invention concerns an x-ray detector with a scintillator with which x-ray radiation can be converted into light, and with a downstream photosensor with which the light generated in the scintillator is detectable.

The invention furthermore concerns a method for operation of an x-ray detector.

2. Description of the Prior Art

For example, an x-ray detector of the above type is known in the article “Flachbilddetektoren in der R\ddot{n}tgendiagnostik” from “Der Radiologe” 5*2003, pages 340-350, Springer-Verlag. In the known case the x-ray detector has a scintillator with which x-ray radiation can be converted into light (scintillator light) and a downstream photosensor with which the light generated in the scintillator can be detected with spatial resolution. The scintillator is, for example, produced from cesium iodide (Csl) and applied on a substrate. The light detected by the photosensor is subsequently read out and processed as an electrical signal. For this the photosensor is executed as an active matrix made from amorphous silicon and forms a detector array with a plurality of detector elements. For detection of the signals a transistor is associated with each detector element as a switching element.

Not all x-ray quanta are absorbed by the scintillator during the x-ray exposure; rather, x-ray quanta penetrate into the underlying photosensor (approximately 30% of the x-ray radiation) and there generate electron-hole pairs (direct conversion in the photosensor) as well as radiation damage. The electron-hole pairs generated in the photosensor lead to a considerable interference signal that in turn appears as a strong noise. Two measures are known in order to avoid or at least to reduce this unwanted x-ray radiation in the photosensor.

A known measure to prevent or to reduce unwanted x-ray radiation in the photosensor is to increase the layer thickness of the scintillator. By this approved it should be achieved that only a few x-ray quanta strike the photosensor; the unwanted x-ray radiation at the photosensor is thus significantly reduced. This measure has the disadvantage that the resolution and the conversion coefficient quickly fall off with increasing layer thickness of the scintillator.

A further measure to prevent or to reduce unwanted x-ray radiation in the photosensor is known from the publication “OPDIMA: Large-area CCD-based X-ray image sensor for spot imaging and biopsy control in mammography” in Proc. SPIE 3659, 150-158 (1999). In the x-ray detector known from this publication fiber optics (fiber optical plate, FOP) are arranged between the scintillator and the photosensor. The optical coupling between scintillator layer and photosensor is ensured by the fiber optics and the proportion of the x-ray radiation (approximately 30%) that strikes the photosensor is attenuated by the fiber optics. Radiation damage as well as direct conversions in the photosensor that lead to a strong noise in the photosensor and therewith to an impairment of the image quality are largely avoided given a sufficient thickness of the fiber optics (1 to 5 mm). Light coupling losses, moiré and resolution losses arise due to the necessary thickness of the fiber optics. The necessary thickness of the fiber optic optics additionally disadvantageously affects the structural height, weight and costs of the x-ray detector.

### SUMMARY OF THE INVENTION

An object of the present invention is to provide an x-ray detector that is compact in design as well as a method for operation of an x-ray detector with which acquisitions of x-ray images at an improved quality are enabled.

The x-ray detector according to the invention has a scintillator with which x-ray radiation can be converted into light and a downstream photosensor with which the light generated in the scintillator can be detected. According to the invention, no detection of the generated light by the photosensor can be implemented for a predeterminable time interval during an irradiation of the scintillator with x-ray radiation, and the luminescence of the scintillator can be detected by the photosensor after the end of the exposure of the scintillator with x-ray radiation.

In the method according to the invention for operation of an x-ray detector, light generated during an x-ray exposure is not detected for a predeterminable time span and a luminescence present after the end of the x-ray exposure is detected.

The light generated in the scintillator is advantageously detectable with spatial resolution.

Because, in accordance with the invention, the light (scintillator light) generated in the scintillator during the x-ray exposure is not detected by the photosensor for a predeterminable time span, electron-hole pairs generated in the photosensor by the x-ray radiation are also not detected as an interference signal. The luminescence of the scintillator thus is detected the photosensor largely without noise.

The scintillator light that arises during the x-ray exposure is thus not detected by the photosensor for a predeterminable time interval, whereby a loss of scintillator light results. However, given selection of a suitable scintillator with a correspondingly long decay behavior this loss of scintillator light is more than compensated by the better noise behavior.

A scintillator material with a decay time between approximately 100 μs and approximately 10 μs is advantageously employed.

Examples of particularly suitable scintillator materials (thus scintillator materials with a correspondingly long decay behavior) are, among other things, gadolinium oxisulfide doped with terbium (Gd₂O₂S:Tb) or zinc cadmium sulfide doped with silver (ZnCdS:Ag) or lanthanum oxibromide doped with terbium (LaOBr:Tb).

The inventive measures can be realized particularly advantageously with photosensors based on CMOS or CCD technology since these can be deactivated and activated in the microsecond range.

Not only can an x-ray image that is largely free of interference signals be generated via the x-ray detector according to claim 1 or, respectively, via the method according to claim 8, but rather a fiber optic (fiber optic plate, FOP) between the scintillator and the photosensor can also be omitted. The scintillator can thus be applied directly on the photosensor. X-ray detectors that can be manufactured cost-effectively are therewith obtained that on the one hand exhibit a simpler design in terms of construction and on the other hand exhibit a lower structural height and a lower weight.

Due to the realizable low structural height and the low weight the inventive x-ray detector is particularly well suited for intraoral applications and for applications in mammography.

Furthermore, in the inventive x-ray detector it is possible to optimize the layer thickness of the photosensor so that x-ray images can be acquired with an improved resolution.

In an embodiment of the inventive x-ray detector the electrical charges generated in the photosensor during an x-ray exposure can be directly discharged. The direct discharge of the electrical charges generated in the photosensor is also known as “blanking”. The photosensor can be switched on again after the x-ray exposure.

It is advantageous to fashion the x-ray detector in order to minimize the proportion of the electrical charges generated given an x-ray exposure of the scintillator. In this embodiment the electrical charges generated in the photosensor can already be directly discharged with the beginning of the x-ray exposure. The photosensor can be switched on again with the end of the x-ray exposure.

In a further embodiment of the x-ray detector, the electrical charges generated in the photosensor can be directly discharged immediately before the beginning of the x-ray exposure. The photosensor can be switched on again immediately after the end of the x-ray exposure. In this variant the proportion of the electrical charges that is generated upon an x-ray exposure of the scintillator is again minimized since the blanking of the photosensor ensues before a possible entrance of the x-ray quanta into the photosensor. By the blanking immediately before the x-ray image acquisition the photosensor is always entirely homogeneously discharged before the next x-ray image is acquired. What is known as a “ghosting” in the x-ray image is reliably prevented with this.

A further preferred embodiment of the inventive x-ray detector is characterized in that the exposure of the scintillator with x-ray radiation and the detection of the luminescence of the scintillator by the photosensor can be repeated at short time intervals.

### BRIEF DESCRIPTION OF THE DRAWINGS

FIG. 1 is a partially cut-away view of an x-ray detector in accordance with the invention.

FIG. 2 is a curve of the light emitted by the scintillator after an x-ray exposure.

### DESCRIPTION OF THE PREFERRED EMBODIMENTS

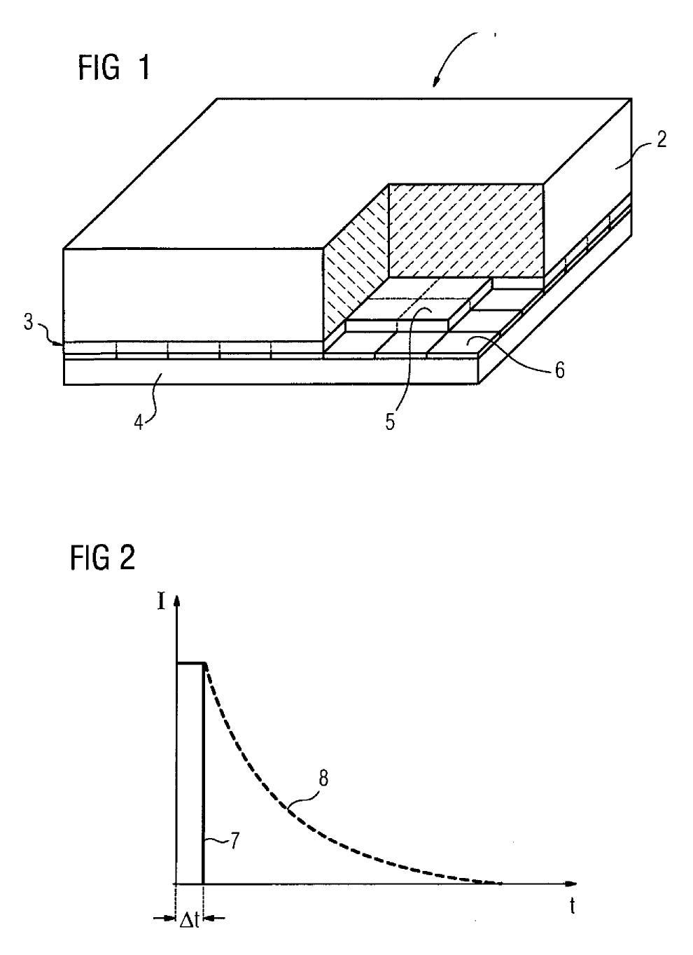

An x-ray detector that comprises a scintillator 2 and a downstream photosensor 3 is designated with 1 in FIG. 1.

Incident x-ray radiation can be converted in the scintillator 2 into light (scintillator light) and can subsequently be detected with spatial resolution by the photosensor 3.

The scintillator 2 is produced from Gd₂O₂S:Tb (gadolinium oxisulfide doped with terbium), for example, and is applied on the substrate 4. The light detected by the photosensor 3 is subsequently read out as an electrical signal and processed. For this, in the shown exemplary embodiment the photosensor 3 is executed as an active matrix made from individual photodiodes 5. An integrated circuit 6 (for example a transistor) is associated as a switching element with every photodiode 5.

During the x-ray exposure not all x-ray quanta are absorbed by the scintillator 2; rather, x-ray quanta (approximately 30% of the x-ray radiation) penetrate into the underlying photosensor 3 and there generate electron-hole pairs (direct conversions in the photosensor 3).

In order to avoid or at least to reduce this phenomenon, according to the invention the light (scintillator light) generated in the scintillator 2 during the x-ray exposure of the x-ray detector is not detected and a luminescence of the scintillator 2 that is present after the end of the x-ray exposure is detected with spatial resolution by the photosensor 3.

For this FIG. 2 shows an example a curve (intensity l dependent on the time t) of the light 8 emitted by the scintillator 2 after an x-ray exposure 7.

The non-detection of the light 8 generated in the scintillator 2 during the x-ray exposure 7 can be achieved in a simple manner in that the electrical charges generated in the photosensor 3 during the x-ray exposure 7 of the scintillator 2 are directly discharged in a time interval Δt. The direct discharge of the electrical charges generated in the photosensor 3 is also designated as a “blanking”. In the curve shown in FIG. 2 this blanking of the photosensor 3 is effected at the beginning of the x-ray exposure 7 and is lifted again with the end of the x-ray exposure 7. The photosensor 3 is therewith blanked (thus detects no scintillator light 8) in the time interval Δt and is switched on again at the end of the time interval Δt. The luminescence 8 of the scintillator 2 can therewith be detected with spatial resolution in the photosensor 3 without occurrence of an interfering x-ray exposure 7. In the inventive solution, an adaptation to various application cases is possible in a simple manner via a change of the position and/or the length of the time interval Δt.

In the framework of the invention it is also possible to utilize the x-ray pulse 7 or the time interval δt as a trigger for the activation of the photosensor 3. Dependent on the application case, the triggering can then ensue with the beginning of the time interval Δt, within the time interval Δt or after the end of the time interval Δt.

Although modifications and changes may be suggested by those skilled in the art, it is the intention of the inventors to embody within the patent warranted heron all changes and modifications as reasonably and properly come within the scope of their contribution to the art.

We claim as our invention:

1-11. (canceled)

12. An x-ray detector comprising:
a scintillator having a surface configured for exposure to incident radiation, said scintillator converting said incident x-ray radiation into light; and
an activatable photosensor disposed to detect the light from said scintillator, said photodetector being inhibited from detecting said light for a predetermined time interval during which said scintillator is exposed to said x-ray radiation, and said photosensor being activated to detect said light only after an end of the exposure of the scintillator to said incident x-ray radiation.

13. An x-ray detector as claimed in claim 12 wherein said photosensor generates electrical charges dependent on said light, and wherein said photosensor is inhibited from detecting said light by directly discharging said electrical charges during said predetermined time interval.

14. An x-ray detector as claimed in claim 13 wherein said photosensor directly discharges said electrical charges at a beginning of said exposure of said scintillator to said incident x-ray radiation, and is activated to accumulate said electrical charges at said end of said exposure.

15. An x-ray detector as claimed in claim 13 wherein said further sensor directly discharges said electrical charges immediately before a beginning of said exposure of said scintillator to said x-ray radiation, and wherein said further sensor begins accumulating said electrical charges immediately after said end of said exposure.

16. An x-ray detector as claimed in claim 12 wherein said detector detects said light from said scintillator with a spatial resolution.

17. An x-ray detector as claimed in claim 12 wherein said predetermined time interval is selected to allow exposure of said scintillator to said incident x-ray radiation and detection of said light by said photosensor to be rapidly repeated.

18. An x-ray detector as claimed in claim 12 wherein said scintillator is comprised of scintillator material having a decay time in a range between approximately 100 μs to approximately 10 s in which light from said scintillator is detectable.

19. An x-ray detector as claimed in claim 18 wherein said scintillator material is gadolinium oxisulfide doped with terbium.

20. An x-ray detector as claimed in claim 18 wherein said scintillator material is zinc cadmium sulfide dopes with silver.

21. An x-ray detector as claimed in claim 18 wherein said scintillator material is lanthanum oxibromide doped with terbium.

22. A method for operating an x-ray detector comprising a scintillator and a photodetector, comprising the steps of:
exposing said scintillator to incident x-ray radiation, thereby causing said scintillator to emit light dependent on said incident x-ray radiation during said exposure to said incident x-ray radiation; and
inhibiting said photosensor from detecting said light for a predetermined time interval after an end of said x-ray exposure, and only thereafter activating said photosensor to detect said light with a spatial resolution.
